(19) United States
(12) Patent Application Publication
(10) Pub. No.: US 2026/0231229 A1
(43) Pub. Date: Aug. 6, 2026

(54) USER EQUIPMENT BEAM REFINEMENT DURING RANDOM ACCESS

(71) Applicant: Nokia Technologies Oy, Espoo (FI)

(72) Inventors: Samantha CAPORAL DEL BARRIO, Aalborg (DK); Smita SHETTY, Bangalore (IN); Sami-Jukka HAKOLA, Oulu (FI)

(21) Appl. No.: 19/155,088

(22) PCT Filed: Jan. 4, 2024
(86) PCT No.: PCT/EP2024/050118

§ 371 Date: Aug. 8, 2025

(30) Foreign Application Priority Data
Feb. 17, 2023 (IN) 202311010714

(51) Int. Cl. H04W 74/0833; H04B 7/06

(52) U.S. Cl. CPC H04W 74/0833; H04B 7/06958

(57) ABSTRACT

There is provided a method, apparatus, and computer program for causing a user equipment to perform: transmitting, to an access network node using a broad beam transmission during a random access procedure, a preamble indicating whether the user equipment is requesting to perform beam refinement for transmission beams during the random access procedure.

### FIELD OF THE DISCLOSURE

The examples described herein generally relate to apparatus, methods, and computer programs, and more particularly (but not exclusively) to apparatus, methods and computer programs for apparatuses.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided an apparatus for a user equipment, the apparatus comprising: at least one processor; and at least one memory comprising software code that, when executed by the at least one processor, causes the apparatus to perform: transmitting, to an access network node using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may be caused to perform: receiving, from the access network node, at least one reference signal during the random access procedure; sweeping the at least one reference signal to determine a narrower transmission beam than the broad beam; and transmitting, during the random access procedure, signaling using the narrower transmission beam.

The signaling using the narrower transmission beam may comprise physical uplink shared channel signaling.

The apparatus may be caused to perform: receiving, from the access network node, an indication of resources that will be used for transmitting the at least one reference signal; and using the indication of resources to locate the at least one reference signal.

The indication of resources may be received in response to the transmission of the preamble.

The at least one reference signal may comprise at least one tracking reference signal.

The preamble may indicate that the user equipment is requesting to perform beam refinement for transmission beams during the random access procedure, and the apparatus may be caused to perform: prior to transmitting the preamble, determining that the user equipment is in a low power state or does not have sufficient power to transmit all signaling for completing the random access procedure using the broad beam, wherein the preamble is transmitted in response to said determining.

According to a second aspect, there is provided an apparatus for an access node, the apparatus comprising: at least one processor; and at least one memory comprising software code that, when executed by the at least one processor, causes the apparatus to perform: receiving, from a user equipment using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may be caused to perform: signaling, to the user equipment, at least one reference signal during the random access procedure; and receiving, from the user equipment, during the random access procedure, signaling using a narrower transmission beam than the broad beam.

The signaling using the narrower transmission beam may comprise physical uplink shared channel signaling.

The apparatus may be caused to perform: signaling, to the user equipment, an indication of resources that will be used for transmitting the at least one reference signal.

The indication of resources may be signaled in response to the receipt of the preamble.

The at least one reference signal may comprise at least one tracking reference signal.

According to a third aspect, there is provided an apparatus for a user equipment, the apparatus comprising means for performing: transmitting, to an access network node using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may comprise means for performing: receiving, from the access network node, at least one reference signal during the random access procedure; sweeping the at least one reference signal to determine a narrower transmission beam than the broad beam; and transmitting, during the random access procedure, signaling using the narrower transmission beam.

The signaling using the narrower transmission beam may comprise physical uplink shared channel signaling.

The apparatus may comprise means for performing: receiving, from the access network node, an indication of resources that will be used for transmitting the at least one reference signal; and using the indication of resources to locate the at least one reference signal.

The indication of resources may be received in response to the transmission of the preamble.

The at least one reference signal may comprise at least one tracking reference signal.

The preamble may indicate that the user equipment is requesting to perform beam refinement for transmission beams during the random access procedure, and the apparatus may comprise means for performing: prior to transmitting the preamble, determining that the user equipment is in a low power state or does not have sufficient power to transmit all signaling for completing the random access procedure using the broad beam, wherein the preamble is transmitted in response to said determining.

According to a fourth aspect, there is provided an apparatus for an access node, the apparatus comprising means for performing: receiving, from a user equipment using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may comprise means for performing: signaling, to the user equipment, at least one reference signal during the random access procedure; and receiving, from the user equipment, during the random access procedure, signaling using a narrower transmission beam than the broad beam.

The signaling using the narrower transmission beam may comprise physical uplink shared channel signaling.

The apparatus may comprise means for performing: signaling, to the user equipment, an indication of resources that will be used for transmitting the at least one reference signal.

The indication of resources may be signaled in response to the receipt of the preamble.

The at least one reference signal may comprise at least one tracking reference signal.

According to a fifth aspect, there is provided a method for a user equipment, the method comprising: transmitting, to an access network node using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the method comprise means: receiving, from the access network node, at least one reference signal during the random access procedure; sweeping the at least one reference signal to determine a narrower transmission beam than the broad beam; and transmitting, during the random access procedure, signaling using the narrower transmission beam.

The signaling using the narrower transmission beam may comprise physical uplink shared channel signaling.

The method may comprise: receiving, from the access network node, an indication of resources that will be used for transmitting the at least one reference signal; and using the indication of resources to locate the at least one reference signal.

The indication of resources may be received in response to the transmission of the preamble.

The at least one reference signal may comprise at least one tracking reference signal.

The preamble may indicate that the user equipment is requesting to perform beam refinement for transmission beams during the random access procedure, and the method may comprise: prior to transmitting the preamble, determining that the user equipment is in a low power state or does not have sufficient power to transmit all signaling for completing the random access procedure using the broad beam, wherein the preamble is transmitted in response to said determining.

According to a sixth aspect, there is provided a method for an access node, the method comprising: receiving, from a user equipment using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the method may comprise: signaling, to the user equipment, at least one reference signal during the random access procedure; and receiving, from the user equipment, during the random access procedure, signaling using a narrower transmission beam than the broad beam.

The signaling using the narrower transmission beam may comprise physical uplink shared channel signaling.

The method may comprise: signaling, to the user equipment, an indication of resources that will be used for transmitting the at least one reference signal.

The indication of resources may be signaled in response to the receipt of the preamble.

The at least one reference signal may comprise at least one tracking reference signal.

According to a seventh aspect, there is provided an apparatus for a user equipment, the apparatus comprising: transmitting circuitry for transmitting, to an access network node using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may comprise: receiving circuitry for receiving, from the access network node, at least one reference signal during the random access procedure; sweeping circuitry for sweeping the at least one reference signal to determine a narrower transmission beam than the broad beam; and transmitting circuitry for transmitting, during the random access procedure, signaling using the narrower transmission beam.

The signaling using the narrower transmission beam may comprise physical uplink shared channel signaling.

The apparatus may comprise: receiving circuitry for receiving, from the access network node, an indication of resources that will be used for transmitting the at least one reference signal; and using circuitry for using the indication of resources to locate the at least one reference signal.

The indication of resources may be received in response to the transmission of the preamble.

The at least one reference signal may comprise at least one tracking reference signal.

The preamble may indicate that the user equipment is requesting to perform beam refinement for transmission beams during the random access procedure, and the apparatus may comprise: determining circuitry for, prior to transmitting the preamble, determining that the user equipment is in a low power state or does not have sufficient power to transmit all signaling for completing the random access procedure using the broad beam, wherein the preamble is transmitted in response to said determining.

According to an eighth aspect, there is provided an apparatus for an access node, the apparatus comprising: receiving circuitry for receiving, from a user equipment using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may comprise: signaling circuitry for signaling, to the user equipment, at least one reference signal during the random access procedure; and receiving circuitry for receiving, from the user equipment, during the random access procedure, signaling using a narrower transmission beam than the broad beam.

The signaling using the narrower transmission beam may comprise physical uplink shared channel signaling.

The apparatus may comprise: signaling circuitry for signaling, to the user equipment, an indication of resources that will be used for transmitting the at least one reference signal.

The indication of resources may be signaled in response to the receipt of the preamble.

The at least one reference signal may comprise at least one tracking reference signal.

According to a ninth aspect, there is provided non-transitory computer readable media comprising program instructions for causing an apparatus for a user equipment to perform: transmitting, to an access network node using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may be caused to perform: receiving, from the access network node, at least one reference signal during the random access procedure; sweeping the at least one reference signal to determine a narrower transmission beam than the broad beam; and transmitting, during the random access procedure, signaling using the narrower transmission beam.

The signaling using the narrower transmission beam may comprise physical uplink shared channel signaling.

The apparatus may be caused to perform: receiving, from the access network node, an indication of resources that will be used for transmitting the at least one reference signal; and using the indication of resources to locate the at least one reference signal.

The indication of resources may be received in response to the transmission of the preamble.

The at least one reference signal may comprise at least one tracking reference signal.

The preamble may indicate that the user equipment is requesting to perform beam refinement for transmission beams during the random access procedure, and the apparatus may be caused to perform: prior to transmitting the preamble, determining that the user equipment is in a low power state or does not have sufficient power to transmit all signaling for completing the random access procedure using the broad beam, wherein the preamble is transmitted in response to said determining.

According to a tenth aspect, there is provided non-transitory computer readable media comprising program instructions for causing an apparatus for an access node to perform: receiving, from a user equipment using a broad beam transmission during a random access procedure, a preamble indicating whether the user equipment is requesting to perform beam refinement for transmission beams during the random access procedure.

The preamble may indicate that the user equipment is requesting to perform beam refinement for transmission of beams during the random access procedure, and the apparatus may be caused to perform: signaling, to the user equipment, at least one reference signal during the random access procedure; and receiving, from the user equipment, during the random access procedure, signaling using a narrower transmission beam than the broad beam.

The signaling using the narrower transmission beam may comprise physical uplink shared channel signaling.

The apparatus may be caused to perform: signaling, to the user equipment, an indication of resources that will be used for transmitting the at least one reference signal.

The indication of resources may be signaled in response to the receipt of the preamble.

The at least one reference signal may comprise at least one tracking reference signal.

According to an eleventh aspect, there is provided a computer program product (e.g., a software code) stored on a media that may cause an apparatus to perform any method as described herein.

According to a twelfth aspect, there is provided an electronic device that may comprise apparatus as described herein.

According to a thirteenth aspect, there is provided a chipset that may comprise an apparatus as described herein.

### BRIEF DESCRIPTION OF FIGURES

Some examples, will now be described, merely by way of illustration only, with reference to the accompanying drawings in which:

FIG. 1 shows a schematic representation of a 5G system;

FIG. 2 shows a schematic representation of a network apparatus;

FIG. 3 shows a schematic representation of a user equipment;

FIGS. 4A to 4B illustrate beam shapes;

FIGS. 5A to 5C illustrate beam shape relative to antenna array use;

FIG. 6 illustrates a signaling diagram;

FIG. 7 illustrates example elements of a RACH configuration element;

FIGS. 8 to 9 illustrate example signaling;

FIG. 10 illustrates example operations that may be performed by apparatus described herein; and

FIGS. 11 to 12 illustrate operations that may be performed by apparatus described herein.

### DETAILED DESCRIPTION

The following describes operations that may be performed for increasing the efficiently of random access procedures. In particular, the following is directed towards providing a mechanism by which a user equipment, UE, can refine its transmission beam from a broad beam to a narrow beam during a random access procedure. This may assist the user equipment in saving energy resources, as a narrower beam may be associated with a lower transmission power than a broad beam.

In the following description of examples, certain aspects are explained with reference to devices that are often capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals, IEEE 802.11, etc.).

3GPP defined Random Access channel (RACH) procedures can be used in a variety of situations, including (at least): Initial Access, small data transmissions in an RRC inactive mode, and in transitions from an RRC inactive mode to an RRC connected mode, as well as in beam failure recovery, connection re-establishment, handover, cell addition.

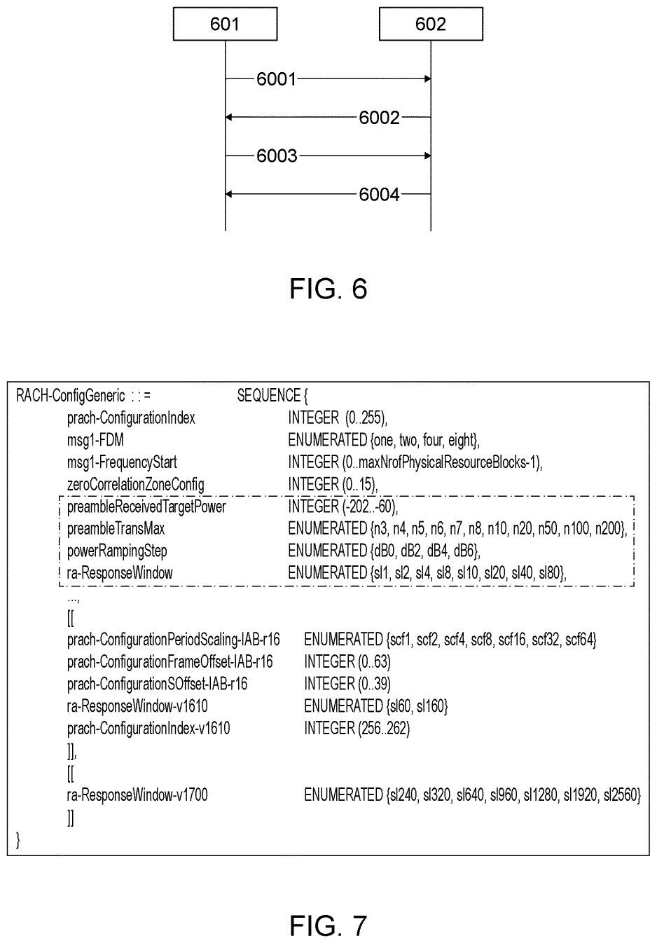

A four step RACH procedure is illustrated with respect to FIG. 6.

FIG. 6 illustrates signaling performed between a UE 601, and an access network node 602.

During 6001, the UE 601 signals the access network node 602. This signaling (which is referred to herein as “msg1”) may comprise a random access preamble, which is carried using a physical random access channel (PRACH). The preamble may be selected based on information comprised in at least one of the SIBs signaled in the SSB(s).

During 6002, the access network node 602 signals the UE 601. This signaling (which is referred to herein as “msg2”) may comprise a random access response (RAR) to the preamble of 6001. The RAR may comprise an uplink allocation that indicates when the signaling of 6003 may be transmitted. The RAR is usable by the UE to confirm that the UE may proceed with the random access procedure. For example, the RAR may comprise an identifier of the preamble comprised in msg1. The RAR may comprise a temporary identifier for the UE (e.g., a cell-radio network temporary identifier), which may be used for identifying the UE during 6002 to 6004.

During 6003, the UE 601 signals the access network node 602. This signaling (which is labelled herein as “msg3”) may comprise an identifier that can be used for contention resolution (which may be useful when multiple UE are attempting to register simultaneously, as there are a limited number of preambles available for transmission in msg1).

During 6004, the access network node 602 signals the UE 601. This signaling (MSG4) may comprise contention resolution signaling.

For the Random Access procedure, as part of or during transmission of msg1 there are certain parameters that the UE uses to determine the target power for transmitting msg1. The 3GPP specification, TS 38.213 gives a formula for performing a PRACH power control calculation. In particular, this formula defines that a RACH transmission power is the minimum of: Pcmax (which is a UE configured maximum output power at that transmission frequency), and/or the sum of PRACH Target+PL (which is the sum of the PRACH target reception power at that transmission frequency and a pathloss at that transmission frequency).

Further parameters are used for ramping up the power used for transmitting msg1. These parameters comprise the time to wait for a random access response from the network in a number of slots (ra-ResponseWindow), a maximum number of retransmissions (preambleTransMax), a size of a power ramping step for PRACH (powerRampingStep), and a target power level at the network receiver side (preambleReceivedTargetPower). These parameters are comprised in a RACH configuration information element, as illustrated in relation to FIG. 7. These parameters may be provided to the UE in a RACH configuration RRC message, such as described in relation to 3GPP TS 38.331.

After sending msg1, the UE waits for a response from the network. When there is no feedback (e.g., msg2) within the time ra-Responsewindow, a 2^{nd} version of msg1 is transmitted using a higher transmission power. The higher transmission power is calculated using a preset calculation. This process continues (e.g., transmitting msg1 at a higher and higher transmission power when no feedback is received within a time window) until the UE either receives a response from the network or the maximum number of transmissions of msg1 is exhausted.

When the maximum number of transmissions is exhausted without the UE receiving a response from the network, then a Random Access failure is declared.

Upon reception of the RAR in msg2 from the network, the UE sends MSG3 using an uplink grant scheduled in msg2. The uplink grant of the RAR comprises the frequency domain and time resource allocation for use by the UE to send msg3.

PRACH is used to carry random access preamble from UE towards access network node (i.e. 5G NR base station). PRACH helps an access network node to adjust uplink timings of the UE.

Multiple Physical-RACH (PRACH) preamble formats are defined in 3GPP, each PRACH preamble format having one or more PRACH orthogonal frequency multiple division (OFDM) symbols, and different cyclic prefix and guard time. Which PRACH preamble configuration to use is provided to the UE in the system information (e.g., in SIB1).

5G NR random access preamble supports two different sequence lengths with various format configurations: a long sequence and a short sequence. The different formats help in wide deployment scenarios. These are explained below with reference to FR1 and FR2.

Frequency bands for 5G NR are separated into two different frequency ranges: Frequency Range 1 (FR1) and Frequency Range 2 (FR2).

FR1 includes sub-6 GHz frequency bands, some of which are bands traditionally used by previous standards, but has been extended to cover potential new spectrum offerings from 410 MHz to 7125 MHz.

FR2 includes frequency bands from 24.25 GHz to 52.6 GHz. Bands in this millimeter wave range have shorter range but higher available bandwidth than bands in the FR1.

The long sequence uses four preamble formats like LTE. These formats are designed for large cell deployment in FR1 (Sub-6 GHz range). They use subcarrier spacing of 1.25 KHz or 5 KHz.

The short sequence uses nine preamble formats. These formats are designed for small cell deployment including indoor coverage. These preamble formats are used for both FR1 (sub-6 GHz) and FR2 (mmwave) ranges. In FR1, it supports 15 or 30 KHz where as in FR2, it supports 60 or 120 KHz. subcarrier spacing.

The msg2 (RAR) of the Random access procedure carries the uplink grant. As mentioned above, this uplink grant indicates to the UE where in frequency and when in time the UE is allowed to transmit msg3. As defined in 3GPP TS 38.213 Section 8.3, this uplink grant largely depends on the k_2 value and sub carrier spacing.

With reference to slots for a PUSCH transmission scheduled by a RAR UL grant, if a UE receives a PDSCH with a random access response message ending in slot for a corresponding PRACH transmission from the UE, the UE transmits the PUSCH in slot: n+k_2+Δ+2μ·Kcell, offset, where k_2 and Δ are provided in 3GPP TS 38.214, and is provided by CellSpecific_Koffset.

As defined in 3GPP, currently if default time domain resource allocation A for normal cyclic prefix (CP) with PUSCH mapping type A is assumed, the UE can be at the scheduled a maximum after 12 slots. In case pusch-TimeDomainAllocationList is provided in pusch-ConfigCommon then the UE can be scheduled for transmitting Msg 3 at a maximum after 38 slots.

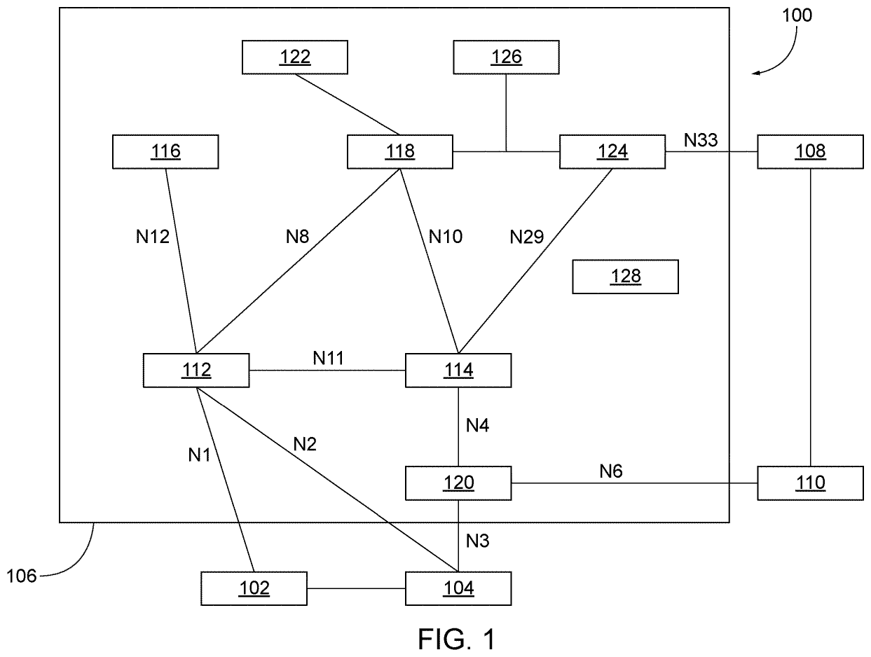

Before describing in detail the examples, certain general principles of a 5G wireless communication system are briefly explained with reference to FIGS. 1 to 3.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

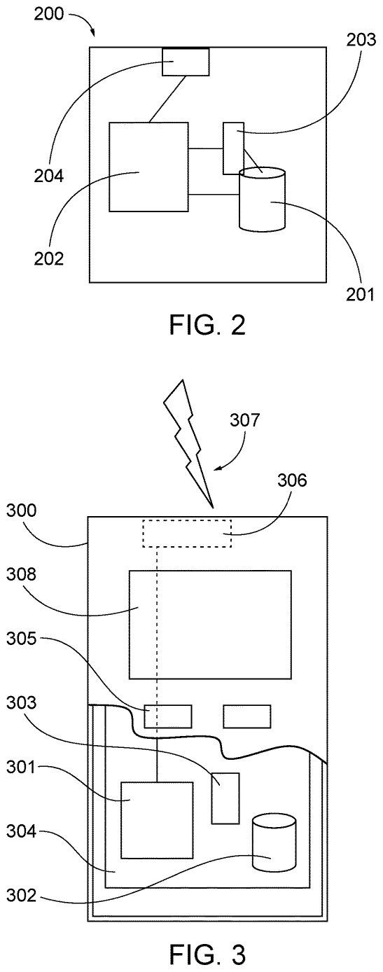

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

How a UE synchronizes (in both time and frequency) to an access point of a radio access network (RAN) is an important part of any communication network.

In 5G NR, synchronization signal blocks (SSBs) are one of the features used for synchronizing these two entities.

An SSB is a signal transmitted by an access network node on a broadcast channel, and comprises a combination of synchronization signal (SS) and Physical Broadcast Channel (PBCH)). An SSB comprises four symbols (e.g., four orthogonal frequency division multiplex (OFDM) symbols): 1 symbol for a primary synchronization signal (PSS), 1 symbol for a secondary synchronization signal (SSS), and 2 symbols for PBCH. An SS burst comprises one or more SSBs.

The SSB transmitted by an access network node comprises system information, which is information usable by a receiving UE to access the radio access network associated with the access network node. The system information is provided in the form of a master information block (MIB) and a plurality of different system information blocks (SIBs). The system information can be divided into Minimum system information and Other system information.

Minimum system information comprises basic information that is to be used for enabling initial access of the UE to a cell, and information for acquiring any other system information.

The minimum system information may comprise:
The MIB, which comprises cell barred status information and physical layer information of the cell required to receive further system information, e.g. CORESET #0 configuration. The MIB is periodically broadcast on the broadcast channel (BCH).
SIB1, which defines the scheduling of other system information blocks and contains information required for initial access. SIB1 is also referred to as Remaining Minimum system information (RMSI), and is periodically broadcast on the downlink shared channel (DL-SCH), and/or sent in a dedicated manner on the DL-SCH to UEs in an RRC connected mode.

The Other system information comprises, amongst other SIB, SIB17. SIB17 carries configurations of Tracking Reference Signal (TRS) resources for UEs operating in a radio resource control idle and/or inactive mode. SIB17 may be transmitted within a periodically occurring time-domain window. SIB17 may be transmitted over a downlink shared channel.

In more detail, Rel-17 defined Tracking Reference Signals for UEs operating in an idle mode. A TRS is used for fine synchronization in time and frequency, Doppler and delay spread information. Synchronization is needed for channel estimation and demodulation. TRS is realized through the Channel State Information-Reference Signal (CSI-RS), and was previously used available for UEs in an RRC connected mode.

UE power saving while the UE is in an RRC idle or an RRC inactive mode may be achieved by providing the connected mode configuration for TRS with CSI-RS for tracking during TRS transmission occasions. The TRS transmitted during TRS occasions may allow UEs in an RRC idle or an RRC inactive mode to sleep longer before waking-up for the UE's paging occasion. The TRS occasions configuration is provided in an SIB (SIB17). The availability of TRS in the TRS occasions is indicated by a layer 1 availability indication comprised in SIB17.

Quasi colocation (QCL) association of a resource set is given towards a synchronization signal block (SSB). Each resource set is given an index of the associated bit in TRS availability indication (indBitID). The validity of such TRS allocation may be configured by network.

The information provided in SSBs (e.g., in the MIB and SIBs) can be used by a UE to synchronize with a radio access network node during Random Access Channel (RACH) procedures.

Beamforming is another concept that is useful in accessing a network via a radio access network.

Beamforming relates to the ability of an apparatus to use an antenna array to transmit and/or receive along a particular direction. Beamforming comprises combining elements in an antenna array in such a way that signals at particular angles experience constructive interference while others experience destructive interference. Beamforming is also referred to as applying spatial filtering for processing signals for directional signal transmission or reception. The improvement compared with omnidirectional reception/transmission is known as the directivity of the array, which increases the gain on each side though impacts reliability of the link when the beams are not aligned.

In mmW (FR2 and beyond), both access network node and UE can apply beamforming techniques. Currently FR2 is deployed with analog beamforming on the UE. This means that there is a single beam transmission at the time and spatial filtering of the transmission spherical coverage. Typically, a UE beam covers up to 90 degrees in the azimuthal plane per panel and can be refined to 22 degrees for a 1×4 linear array.

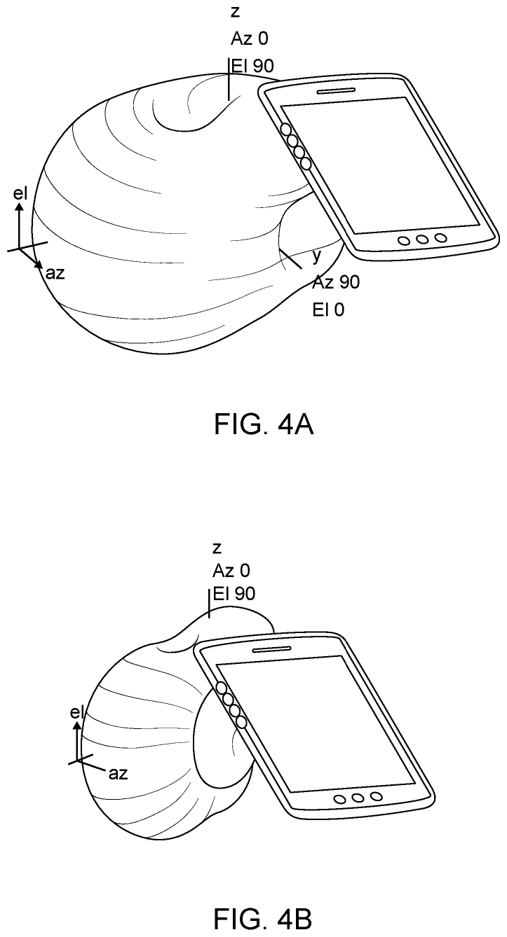

Front-to-back antenna gain variation on UE may be up to 10-15 dB, which means that using the correct antenna panel may result in the UE being unable to receive/transmit with the access network node. This is illustrated with reference to FIGS. 4A and 4B.

FIG. 4A illustrates a broad beam antenna pattern on a 1×4 array on a UE. The beamwidth varies from 90 to 22 degrees and front-to-back radio of approximately 15 dB.

FIG. 4B illustrates a narrow beam antenna pattern on a 1×4 array on a UE. The beamwidth varies from 90 to 22 degrees and front-to-back radio of approximately 15 dB.

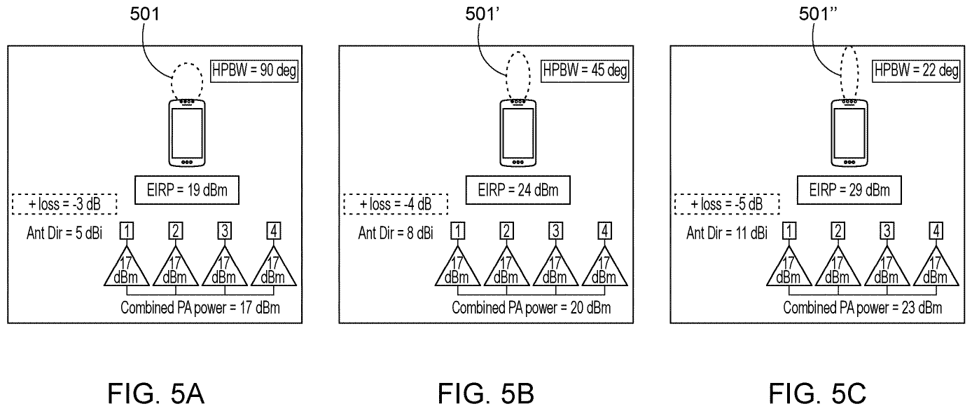

In FR2, the UE uses a beam refinement procedure to determine how to narrow its transmission beam (e.g., how to make highly directive transmission beams) towards the gNodeB for increasing the uplink coverage relative to the use of a broader transmission beam. This is illustrated with respect to FIGS. 5A to 5C, which illustrate UE beam refinement with increasing number of active antenna elements from FIG. 5A to FIG. 5C.

FIG. 5A illustrates a beam shape 501 obtained with a quarter use of the antenna array.

FIG. 5B illustrates a beam shape 501′ obtained with a half use of the antenna array. The beam shape 501′ is narrower than beam shape 501.

FIG. 5C illustrates a beam shape 501″ obtained with full use of the antenna array. The beam shape 501″ is narrower than beam shape 501′.

One concept that can be used for facilitating the determination of a narrow beam is beam correspondence.

Beam correspondence refers to the situation in which beams selected for downlink transmission and reception can also be used for uplink transmission and reception. This means that both downlink and uplink transmissions will happen on the same beam.

The beam correspondence requirement can be satisfied with the presence of at least one of Synchronisation Signal Block (SSB) transmissions and Channel State Indicator-Reference Signals (CSI-RS), and assuming that some type of Quasi-colocation (QCL) is maintained between the SSB and CSI-RS signals.

Transmission/Receive (Tx/Rx) beam correspondence at an access network node holds when at least one of the following conditions is satisfied:
access network node is able to determine an access network node Rx beam for the uplink reception based on UE's downlink measurement on access network node's one or more Tx beams.
access network node is able to determine an access network node Tx beam for the downlink transmission based on access network node's uplink measurement on access network node's one or more Rx beams.

Tx/Rx beam correspondence at UE holds when the Tx beam of the UE can be verified as corresponding to a downlink beam of an access network node by the UE measuring a downlink reference signal.

When the UE is unable to meet beam correspondence requirements autonomously, the UE may meet the requirements with uplink beam sweeping and by meeting preconfigured UE beam correspondence tolerance requirements. In beam sweeping, an access network node may measure an uplink sounding reference signal transmitted by a UE to determine a best UE uplink beam, and provide information about these measurements to the UE. The UE may use this information for help in meeting the UE beam correspondence requirements.

Beam correspondence has been studied in Rel-16 for UEs in a Connected mode (e.g., for UEs that are in a Radio Resource Control (RRC) connected mode) and concluded in a set of requirements with and without uplink beam sweeping for the UE.

Rel-16 RAN4 3GPP TS 38.101-2 specification for Connected mode beam correspondence is as follows.

The beam correspondence requirement for power class 3 UEs consists of three components: UE minimum peak EIRP (as defined in Clause 6.2.1.3 of 3GPP TS 38.101-2), UE spherical coverage (as defined in Clause 6.2.1.3 of 3GPP TS 38.101-2), and beam correspondence tolerance (as defined in Clause 6.6.4.2 of 3GPP TS 38.101-2).

EIRP (Effective Isotropic Radiated Power) is the measured radiated power of an antenna in a specific direction. It is also called Equivalent Isotropic Radiated Power. EIRP is the output power when a signal is concentrated into a smaller area by the Antenna. The EIRP can take into account the losses in transmission line, connectors and includes the gain of the antenna. It is represented in dB. Enter the transmitted power, cable loss and antenna gain to calculate the EIRP (Effective Isotropic Radiated Power).

The beam correspondence requirement is fulfilled when the UE satisfies one of the following conditions, depending on the UE's beam correspondence capability Information element “beamCorrespondenceWithoutULBeamSweeping”, as defined in TS 38.306:
If “beamCorrespondenceWithoutULBeamSweeping” is supported, the UE will meet the minimum peak EIRP requirement according to Table 6.2.1.3-1 of 3GPP TS 38.101-2 and spherical coverage requirement according to Table 6.2.1.3-3 of 3GPP TS 38.101-2 with its autonomously chosen UL beams and without uplink beam sweeping. Such a UE is considered to have met the beam correspondence tolerance requirement.
If “beamCorrespondenceWithoutULBeamSweeping” and “beamCorrespondenceSSB-based-r16” are supported, the UE will meet the minimum peak EIRP requirement according to Table 6.2.1.3-1 of 3GPP TS 38.101-2 and spherical coverage requirement according to Table 6.2.1.3-3 of 3GPP TS 38.101-2 using the side conditions for SSB based enhanced beam correspondence requirements as defined in Clause 6.6.4.3.2 of 3GPP TS 38.101-2.
If “beamCorrespondenceWithoutULBeamSweeping” and “beamCorrespondenceCSI-RS-based-r16” are supported, the UE will meet the minimum peak EIRP requirement according to Table 6.2.1.3-1 and spherical coverage requirement according to Table 6.2.1.3-3 of 3GPP TS 38.101-2 using the side conditions for CSI-RS based enhanced beam correspondence requirements as defined in Clause 6.6.4.3.3 of 3GPP TS 38.101-2.
If “beamCorrespondenceWithoutULBeamSweeping” is not present, the UE will meet the minimum peak EIRP requirement according to Table 6.2.1.3-1 of 3GPP TS 38.101-2 and spherical coverage requirement according to Table 6.2.1.3-3 of 3GPP TS 38.101-2 with uplink beam sweeping. Such a UE will meet the beam correspondence tolerance requirement defined in Clause 6.6.4.2 and will support uplink beam management, as defined in TS 38.306.
If “beamCorrespondenceWithoutULBeamSweeping” is not present and “beamCorrespondenceSSB-based-r16” is supported, the UE will meet the minimum peak EIRP requirement according to Table 6.2.1.3-1 of 3GPP TS 38.101-2 and spherical coverage requirement according to Table 6.2.1.3-3 of 3GPP TS 38.101-2 with uplink beam sweeping using the side conditions for SSB based enhanced beam correspondence requirements as defined in Clause 6.6.4.3.2 of 3GPP TS 38.101-2. Such a UE will meet the beam correspondence tolerance requirement defined in Clause 6.6.4.2 of 3GPP TS 38.101-2 and will support uplink beam management, as defined in TS 38.306.
If “beamCorrespondenceWithoutUL-BeamSweeping” is not present and “beamCorrespondenceCSI-RS-based-r16” is supported, the UE will meet the minimum peak EIRP requirement according to Table 6.2.1.3-1 of 3GPP TS 38.101-2 and spherical coverage requirement according to Table 6.2.1.3-3 of 3GPP TS 38.101-2 with uplink beam sweeping using the side conditions for CSIRS based enhanced beam correspondence requirements as defined in Clause 6.6.4.3.3 of 3GPP TS 38.101-2. Such a UE will meet the beam correspondence tolerance requirement defined in Clause 6.6.4.2 of 3GPP TS 38.101-2 and will support uplink beam management, as defined in TS 38.306.

In Rel-18, requirements for beam correspondence for UEs currently in a radio resource control (RRC) inactive mode and/or an RRC idle mode were specified. The requirements related to the enhancement of beam correspondence during an initial access state and during an RRC inactive mode, the enhancement of beam correspondence when SSB-based and without uplink beam sweeping, and the enhancement of beam correspondence for initial access, with the verification of beam correspondence being based on a minimum of msg1 spherical coverage. Spherical coverage is an uplink measure of how much of a transmitted sphere can be received above a power threshold (e.g., as x dbm). This uplink measure may be expressed as a percentage. Different UE uplink beams will perform different in the spherical coverage.

Moreover, Rel-18 NR is proposing enhancements for FR2, including objectives for defining UE beam correspondence requirements for a UE operating in RRC inactive and initial access states.

These FR2 beam correspondence objectives relate to: specifying UE beam correspondence requirements for initial access and RRC inactive mode, for SSB-based beam correspondence without uplink beam sweeping, specifying, for RRC_INACTIVE at least requirements for Random Access small data transmission (SDT) and Configured Grant SDT, ensuring that requirements for other transmissions within the RRC inactive mode are not precluded, specifying, for initial access, requirements and verification of beam correspondence requirements based on at least msg1 spherical coverage, and studying the potential impact on testability aspects (e.g., test time).

The Rel-18 beam correspondence requirement work will focus on ensuring good Random Access Channel (RACH) performance and uplink coverage through UE beam correspondence requirements during RRC idle mode and RRC inactive mode including SDT. This is aimed at providing large potential for UE power saving opportunities and improvements in latency and signaling overhead reduction.

Further future areas of development relate to refining beam definitions, including whether a broad beam (also referred to as a “rough beam”) or a narrow beam (also referred to as a “fine beam”) is used. A beam may be considered to comprise a spatial filter. A broad beam may be formed by activating a single antenna element in an antenna array (e.g., using a single antenna element for transmitting a signal). A narrow beam may be formed by activating multiple (e.g., all) antenna elements in an antenna array.

There are several options for this.

For example, as a first option, beam refinement in an RRC inactive mode and initial access state can be performed in the same way as defined for the RRC connected mode. For this example, the same SSB configuration as the current SSB RRC connected case can be used, or a modified version of this SSB configuration can be used.

A second option may be a combination of the first and second options. In such a case, beam refinement may be performed in Configured Grant-SDT (CG-SDT), but is not performed in Random Access-SDT (RA-SDT) and initial access cases, or beam refinement in discontinuous reception may be performed but less efficiently than for continuous reception.

As a third option, a rough beam or fine beam used in initial access is up to UE implementation and requirements are implementation agnostic.

Beam correspondence requirements have currently only been defined in connected mode in 3GPP. So far, there are no radio access network requirements for beam correspondence for UEs operating in RRC Inactive and Idle modes.

3GPP Beam Correspondence requirements are defined for 5G NR FR2 bands, where beam alignment would be useful for overcoming challenging propagating conditions, such as high loss. FR2 bands can have huge bandwidths to cater use cases requiring higher data rates. The UE can refine its beam to increase antenna gain, hence peak radiated power in a certain direction.

Nevertheless, beam refinement procedures are currently only specified for use by UEs in an RRC Connected mode, where the network may schedule CSI-RS with repetition ‘on’, and the UE may use these received reference signals and beam correspondence principles to refine its transmission beam. The scheduling of CSI-RS with repetition “on” may comprise an aperiodic trigger that indicates to the UE that the CSI-RS uses the same spatial filter (e.g., beam) as is to be used for uplink transmissions. This means that the UE can then use this reference signal for beam refinement when the UE is operating in an RRC connected mode. These reference signals are not available to UEs operating in RRC Inactive and Idle modes. There is no defined procedure enabling a UE to refine its beam when the UE is operating in RRC Inactive and Idle modes.

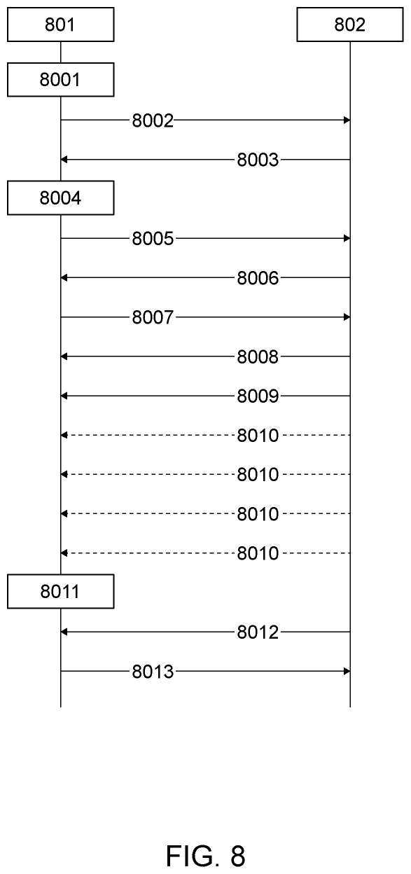

How beam refinement is performed for connected mode UEs is illustrated with respect to FIG. 8, which illustrates signaling between a UE 801 and an access network node 802.

8001 to 8006 relate to an initial access procedure.

During 8001, the UE 801 determines to use a broad transmission beam to signal PRACH on an SSB (e.g., to signal msg1).

The SSB used for this transmission may be selected using an indication of RACH Occasion resources indicated in an SIB (e.g., in SIB2). A RACH Occasion is a resource specified by an area in a time and frequency domain that are available for the reception of a RACH preamble.

For example, in NR, a synchronization signal (e.g., SSB) may be associated with a respective beam, and the UE may select a specific for sending the RACH preamble. In order for the access network to determine which beam has been selected by the UE for uplink transmission of the RACH preamble, a mapping is defined between the synchronization signal and RACH Occasion. Therefore, by detecting which RACH Occasion the UE sends the RACH preamble to, the access network node may determine which synchronization signal beam has been selected by the UE.

During 8002, the UE signals msg1 to the access network node 802 using the broad transmission beam.

During 8003, the access network node 802 signals msg2 to the UE.

During 8004, the UE 801 determines to signal msg3 to the access network node 802 using a broad transmission beam.

During 8005, the UE 801 signals msg3 to the access network node 802 using the broad transmission beam.

During 8006, the access network node 802 signals msg4 to the UE 801.

During 8007, the access network node 802 and the UE 801 are exchanging messages while the UE is in an RRC connected mode.

During 8008, the access network node 802 signals the UE 801. This signaling comprises an RRC configuration for CSI-RS, including a repetition configuration.

During 8009, the access network node 802 signals the UE 801. This signaling comprises a downlink control information activation of CSI-RS with repetition “on”.

8010 relates to UE beam refinement, and comprises a plurality of transmissions from the access network node 802 to the UE 801 comprising CSI-RS with repetition on.

During 8011, the UE determines that it can use a narrow transmit and/or narrow receive beam.

During 8012, the access network node 802 signals the UE 801 on the physical downlink shared channel.

During 8013, the UE 801 signals the access network node 802 on the physical uplink shared channel.

Moreover, 3GPP standards do not mandate the kind of beam the UE needs to use for msg1 and msg3 of a four step RACH procedure. In practice, the UE may be configured to use a broad beam in cell search scenarios in order to optimize the coverage in angular domain, although this is currently left up to UE implementation. This practice may impact maximum achievable radiated power. There is also a possibility that the uplink msg1 and/or msg3 transmission(s) cannot be decoded by the receiving access network node. For example, the uplink msg1 and/or msg3 transmissions may not be decoded by the receiving access node when the UE is not using the right transmission beam for the UE's uplink transmission (e.g., the uplink transmission is being directed in a different direction to the access network node). When the uplink msg1/msg3 are not received as a result of the incorrect directivity of the uplink beam, the transmission power used to transmit these messages may be increased to mitigate against this.

During the Random Access procedure (which may be performed, for example, during handover), there could be a scenario such as cell edge where the UE is power limited. In such cases, the UE may have just enough power amplifier power to send msg1 with a broad beam comprising the preamble, but not have enough power to successfully transmit msg3 of the 4-step Random Access procedure (especially as msg3 comprises a payload as well).

One way in which the UE can mitigate this and ensure msg3 reaches the access network node is by increasing the transmission antenna gain by refining the UE's transmission beam further such that it has a very narrow beam. However, it is difficult for the UE to determine its best Tx narrow beam during PRACH when the latest possible uplink grant allocation given in msg2 is only 38 slots (i.e. 4.75 ms in 120 KHz Sub-carrier spacing−0.125 ms*38 slots as described above). It is therefore unresolved how a UE can use different transmission beams and/or spatial filters during PRACH.

The present application addresses at least one of these issues by illustrating mechanisms for allowing a UE operating in any RRC mode (e.g., RRC Inactive mode, RRC connected mode, and/or RRC Idle mode) to indicate to an access network node that the UE would like to refine its transmission beam during the RACH procedure.

For example, the UE may transmit, to the access network node, a request that the access network node transmit additional reference signals between the UE transmitting msg1 and msg3 during the RACH procedure. The UE may use the received additional reference signals to refine its transmission beam from a broad beam used for transmission of msg1 to a narrow beam used for transmission of msg3. In other words, for the UE to refine its Tx beam for msg3 specifically, the UE can be provided with additional reference signals between msg1 and msg3 on which the UE can further sweep its receive beam to deduce the UE's preferred (e.g., optimal) transmission narrow beam.

There is further provided a dynamic reference signal allocation from the network to the UE (depending on the UE indicating that the UE would like to refine its transmission beam from a broad beam to a narrow beam), and such signaling of this reference signal allocation to the UE via msg2. For example, the dynamic signal allocation may comprise a TRS activation signal to indicate that the TRS transmission will be transmitted.

This, and the following described techniques, are particularly useful when performed by power limited UEs (e.g., UEs operating in an RRC idle mode, an RRC inactive mode, and/or in a mode in which their available battery power has fallen below a predetermined threshold). This is because the UE can save energy by transmitting using a narrow beam transmission sooner than available in prior known techniques. In particular, these additional reference signals are most useful for the cases where the UE is power limited in msg1 with a broad transmission beam, because such a UE would not have enough power to successfully send msg 3. By signaling the request for additional reference signal transmissions to the network, the effect of a UE's low power state can be mitigated.

Although these techniques are especially useful for power limited UEs (and the following examples are framed in this context for clarity), it is understood that the presently described techniques are not limited to such examples, and that there are analogous advantages for a UE performing the presently described techniques when not power limited. For example, a UE in an RRC connected mode may perform the presently described techniques and save energy resources relative to a UE in an RRC connected mode that does not perform the presently described techniques.

The access network node may use TRS for IDLE/INACTIVE mode UEs to enable UE to refine its beam based on UE indication.

The following proposes the configuration of an on-demand TRS (PRACH-triggered) in SIB1 that may be performed regardless of whether the UE is in an RRC idle mode, an RRC inactive mode, or an RRC connected mode. Certain preambles for UE to indicate the need for beam refinement may be reserved and/or allocated (e.g., in SIB1).

The TRS configuration may be provided in at least one SIB. For example, the TRS configuration may be comprised in SIB1, or SIB17, or both SIB1 and SIB17.

The TRS configuration may indicate one or multiple TRS resource sets associated with the same SSB index in order to provide more resources (e.g., more time domain resources) for the beam refinement.

The TRS configuration may be transmitted in response to receiving a preconfigured RACH preamble that is associated with the scheduling, by the access network node, of at least one TRS transmission between the transmission of msg2 and msg3.

Therefore, the UE may indicate to the access network node during RACH procedure (e.g., through the UE's selection of preamble for msg1) that additional reference signals are requested to be transmitted between msg2 and msg3 for transmitting msg3 with sufficient radiated power.

In response to this request, the access network node schedules and transmits TRS before providing an uplink grant for Msg3. The TRS may be scheduled using at least one of DCI scheduling RAR, or directly in RAR of msg2.

The UE subsequently uses TRS scheduled between Msg2 and Msg3 for refining its beam.

Using current definitions in 3GPP TS 38.331, the highest configurable allocation of TRS is two consecutive slots with 2 symbols per slot TRS for a UE operating in an idle mode with a periodicity of 10 slots. Therefore, using the presently described techniques, this amounts to a maximum of four occasions to refine UE beam every 1.25 ms in FR2 120 KHz sub carrier spacing (SCS). Assuming a max TRS allocation of 4 OFDM symbols for 10 slots, the UE can try 4 different receive beams within 1.2 ms, and a latest uplink grant timing of 38 time slots, that leaves the UE with 12 occasions for sweeping the Rx beam before msg3 is to be transmitted. This means that the UE can even perform receive filtering for improving the accuracy of beam refinement.

When the TRS configuration is signaled via SIB17, the TRS occasions can be configured to UEs in in an RRC idle or an RRC inactive mode via the information element labelled “TRSResourceSetConfig” (in SIB17). “TRSResourceSetConfig” can contain up to 64 “TRSResourceSets”. Each TRSResourceSet configures a set of non-zero-power (NZP)-CSI-RS resources (2 or 4 resources).

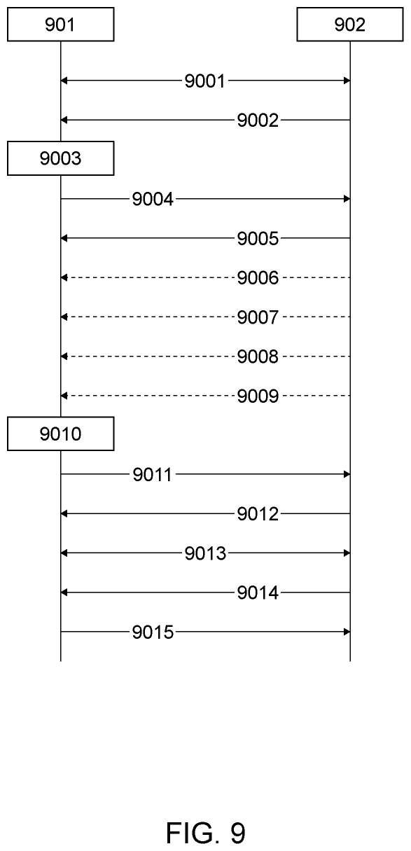

This process is illustrated with respect to at least FIGS. 9 to 12.

FIG. 9 illustrates signaling that may be performed between a UE 901 and an access network node 902. Throughout the following, msg1, msg2, msg3, and msg4 may have the same functions as described above in reference to FIG. 6. For example, msg1 may comprise a preamble for initiating a random access procedure between a UE and an access network node, msg2 may comprise a random access response that comprises an uplink grant allocation on which the UE may transmit msg3, msg3 may comprise signaling for enabling contention resolution for the UE accessing the radio access network, and msg4 may comprise an acknowledgement to the contention resolution signaling of msg3.

During 9001, the UE 901 and access network node 902 exchange signaling according to the UE being in an idle mode and/or inactive mode.

During 9002, the access network node 902 broadcasts a synchronization signal burst. This synchronization signal may comprise at least one SIB. The synchronization signal may comprise an SIB1 that comprises a preamble grouping for use by the UE to indicate whether or not beam refinement between msg1 and msg3 is requested. The synchronization signal may comprise an SIB17 that comprises a configuration for a TRS for a UE operating in an idle mode (e.g., a periodicity and/or a validity of the TRS). The access network node may be able to disable this function when not needed with the validity functionality of TRS.

9003 to 9012 relate to an initial access procedure.

During 9003, the UE 901 determines to use a broad transmission beam for transmitting msg1, and determines that beam refinement is to be requested in advance of transmitting msg3. This latter determination may be in response to determining that the UE is in a low power state. The UE may be in a low power state when the UE is in an energy limited mode (e.g., in an RRC idle and/or an RRC inactive mode). The UE may be in a low power state when the UE determines that the UE has less than a predetermined threshold of battery power available at the UE.

During 9004, the UE 901 signals the access network node 902. This signaling may comprise msg1. This signaling may comprise a preamble transmitted on a PRACH on a synchronization signal block. This signaling may comprise a dedicated preamble that indicates (to the access network node) that reference signals for beam refinement are requested to be transmitted between the transmission of msg1 and msg2.

During 9005, the access network node 902 signals the UE 901. This signaling may comprise msg2. This msg2 may be configured to indicate that TRS will be triggered for the UE operating in an idle mode before the msg uplink grant request is transmitted. The receipt of msg2 itself may implicitly indicate that TRS will be triggered for the UE. Msg2 may be configured to comprise an explicit indication that TRS will be trigger for the UE. If the UE did not receive an msg2, the UE 901 may attempt to retransmit msg1 using a higher power than the power at which msg1 was previously transmitted (e.g., the transmission power used to transmit msg1 “ramps up”).

9006 to 9009 represent a plurality of TRS signals being transmitted by the access network node 902 for receipt by the UE 901.

During 9010, the UE determines that the UE has refined its transmit and/or receive beam enough that the UE can use a narrow transmit beam to transmit msg3.

During 9011, the UE 901 signals the access network node 902. This signaling may comprise msg3. This signaling may be transmitted using a narrow beam. The narrow beam may have been obtained from the refining of 9006 to 9010).

During 9012, the access network node 902 signals the UE 901. This signaling may comprise msg4.

During 9013, the UE 901 and access network node 902 communicate according to an RRC connected mode.

During 9014, the access network node 902 signals the UE 901 using a physical downlink shared channel.

During 9015, the UE 901 signals the access network node 902 using a physical uplink share channel.

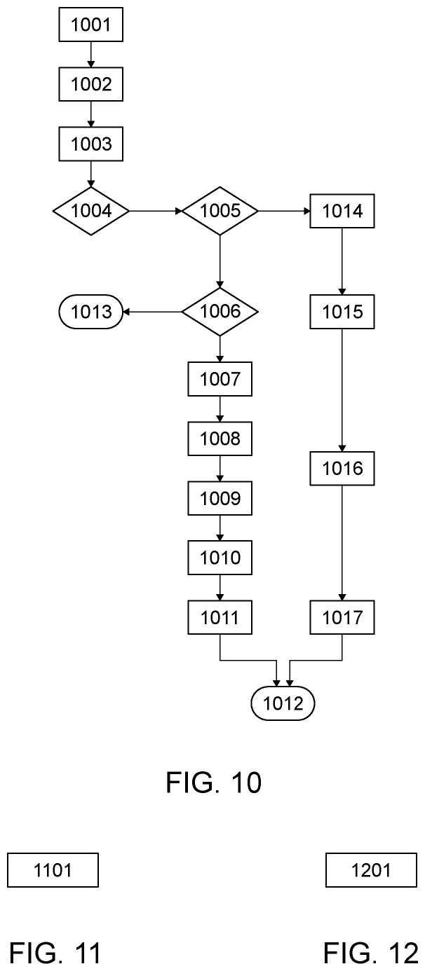

These operations of FIG. 9 are illustrated with respect to FIG. 10, where 1001 to 1002 represents operations to be performed by an access network node, and 1003 to 1015 relate to operations to be performed by a UE.

During 1001, the access network node broadcasts SIB1. This SIB1 indicates at least one preamble grouping for use for a UE to indicate that UE beam refinement is to be requested during a RACH procedure. For example, a preamble from a first group (group 1) may be used to indicate that TRS transmission for beam refinement is requested by the UE, while a preamble from a second group (group 2) may be used to indicate that TRS transmission for beam refinement is not requested by the UE.

Compared to current 3GPP defined SIB1, the present SIB1 comprises a new field of the “RACH-ConfigGeneric” field comprised in the SIB1, which is labelled “prach-ConfigurationIndex-BR” herein. This “prach-ConfigurationIndex-BR” field will have the information about the preamble the network will use to allow beam refinement between msg1 and msg3. For example, the “prach-ConfigurationIndex-BR” field may comprise an indication of the preamble(s) of group 1 and/or an indication of the preamble(s) of group 2.

During 1002, the access network node broadcasts SIB17. This SIB17 comprises a TRS configuration for use when the UE is operating in an RRC idle mode and/or in an RRC inactive mode.

During 1003 to 1006, the UE makes a series of determinations.

During 1003, the UE receives and decodes MIB, SIB1, and SIB2 or a handover command to calculate a power to use for PRACH transmission of a random access preamble.

During 1004, the UE determines whether the UE can transmit at the calculated power with the power available to the UE while using a broad beam.

When the UE determines during 1004 that the UE can transmit at the calculated power with the power available to the UE while using a broad beam, the UE proceeds to 1005.

During 1005, the UE determines whether transmitting at the calculated power with the power available to the UE while using a broad beam would bring the UE to below a minimum power threshold.

When the UE determines during 1005 that transmitting at the calculated power with the power available to the UE while using a broad beam would bring the UE to power limitation, the UE proceeds to 1006.

During 1006, the UE determines whether the UE can refine its beam using an antenna element array. This array may be an FR2-based array when the frequencies involved are in FR2. However, it is understood that the presently described techniques may be applied to frequencies within ranges lying outside of FR2 (e.g., above FR2) in other examples.

When the UE determines during 1006 that the UE can refine its beam using an FR2-based array, the UE proceeds to 1007.

During 1007, the UE uses a dedicated preamble (e.g., from group 1) to indicate to the network that the UE needs additional reference signals between msg2 and msg3 in order for the UE to refine its transmission beam.

During 1008, the UE receives an indication that activation of TRS for use in idle mode has been enabled. This indication may be received in, for example, msg2.

During 1009, the UE sweeps its receive narrow beams over a plurality of received TRS signals to infer a “best” transmission beam for transmitting msg3.

During 1010, the UE sends msg3 to the access network node using the narrow transmission beam determined during 1009.

During 1011, the UE receives msg4.

During 1012, the UE is RRC connected.

When the UE determines during 1004 that the UE cannot transmit at the calculated power with the power available to the UE while using a broad beam, the UE proceeds to 1013.

Similarly, when the UE determines during 1006 that the UE cannot refine its beam using an FR2-based array, the UE proceeds to 1013.

During 1013, the UE determines to use another SSB and/or another transmission reception point (TRP) to connect to the access network node and enter an RRC connected mode.

When the UE determines during 1005 that transmitting at the calculated power with the power available to the UE while using a broad beam would not bring the UE to power limitation, the UE proceeds to 1014.

During 1014, the UE determines to use a dedicated preamble (e.g., from group 2) to indicate to the network that the UE does not need additional reference signals between msg2 and msg3 in order for the UE to refine its transmission beam.

During 1015, the UE receives msg2. This msg2 comprises an uplink grant with a broad beam. This msg2 does not comprise an indication that activation of TRS for use in idle mode has been enabled.

During 1016, the UE sends msg3 to the access network node using the broad beam grant received during 1015.

During 1017, the UE receives msg4, before proceeding to 1012.

When the above-described functionality of FIGS. 9 and 10 is implemented, a UE that determines itself to be power limited may request that TRS transmission be enabled before the UE transmits msg3. This allows the UE to refine its uplink transmission beam by sweeping the downlink TRS reception. It is up to the access network node to determine whether to agree to or disregard the UE request based on the network implementation. For example, the network can disregard the UE indication in case of load or other network conditions where it would be too disadvantageous to the network and other users to use network resources for transmitting the additional TRS signals.

It is understood that although the above describes the use of TRS as providing an additional reference signal on which to perform beam refinement, that the presently described techniques are not limited in this way.

FIGS. 11 and 12 illustrate some features of the above-mentioned examples. It is therefore understood that some of the below mentioned operations may find correspondence in the above examples.

FIG. 11 illustrates operations that may be performed by an apparatus for a user equipment.

During 1101, the user equipment transmits, to an access network node using a broad beam transmission during a random access procedure, a preamble indicating whether the user equipment is requesting to perform beam refinement for transmission beams during the random access procedure.

Beam refinement relates to the process of determining a narrower beam for transmission than was previously used for transmission. In other words, beam refinement relates to the process of determining a more directive beam for transmission than was previously used for transmission. In the present case, the user equipment is requesting to perform beam refinement relative to the beam used for transmitting the preamble in order that another transmission of the RACH process (e.g., msg3) can be transmitted using a narrower beam than the preamble's transmission beam.

The request to perform beam refinement may comprise a request to transmit reference signals for enabling the using equipment to perform beam refinement. For example, the request to perform beam refinement may comprise a request for the access network node to transmit TRS between receipt of the preamble and receipt of msg3.

The request to perform beam refinement may comprise a request to the access network node to provide an uplink grant for transmitting msg 3 that during a latest possible transmission opportunity. This may be useful to maximize the number of opportunities during which the UE may perform beam refinement mechanisms.

The preamble may indicate that the user equipment is requesting to perform beam refinement for transmission of beams during the random access procedure. The UE may subsequently receive, from the access network node, at least one reference signal during the random access procedure, sweep the at least one reference signal to determine a narrower transmission beam than the broad beam, and transmit, during the random access procedure, signaling using the narrower transmission beam. The term “sweep” here refers to the network signaling multiple downlink beams using the same spatial filter, and the UE using multiple (different) refined receive beams to determine which receive beam is receiving the downlink beam with the highest power. This receive beam corresponds to the best aligned receive beam.

The signaling using the narrower transmission beam may comprise physical uplink shared channel signaling. In other words, the narrow transmission beam may comprise an msg3.

The UE may receive, from the access network node, an indication of resources that will be used for transmitting the at least one reference signal, and use the indication of resources to locate the at least one reference signal. The indication of resources may comprise an SIB. The indication of resources may comprise an SIB17 (e.g., which defines TRS). The indication of resources may comprise an SIB1.

The indication of resources may be received in response to the transmission of the preamble. For example, the indication of resources may be comprised in a random access response. In other words, the indication of resources may be comprised in an msg2.

The at least one reference signal may comprise at least one tracking reference signal.

The preamble may indicate that the user equipment is requesting to perform beam refinement for transmission beams during the random access procedure. In such a case, the UE may, prior to transmitting the preamble, determine that the user equipment is in a low power state or does not have sufficient power to transmit all signaling for completing the random access procedure using the broad beam, wherein the preamble is transmitted in response to said determining. For example, the UE may determine that the UE is in an RRC Idle mode, an RRC inactive mode, and/or have a batter power level below a predetermined threshold.

FIG. 12 illustrates operations that may be performed by an apparatus for an access node (e.g., a gNB or some other radio access network node). The access node may be the access node mentioned above in relation to FIG. 11.

During 1201, the access node receives from a user equipment using a broad beam transmission during a random access procedure, a preamble indicating whether the user equipment is requesting to perform beam refinement for transmission beams during the random access procedure. The user equipment may be as described above in relation to FIG. 11. Further, the above comments made above in relation to FIG. 11 may equally apply in relation to corresponding features of FIG. 12.

The preamble may indicate that the user equipment is requesting to perform beam refinement for transmission of beams during the random access procedure. The access node may be caused to signal, to the user equipment, at least one reference signal during the random access procedure, and receive, from the user equipment, during the random access procedure, signaling using a narrower transmission beam than the broad beam.

The signaling using the narrower transmission beam may comprise physical uplink shared channel signaling. For example, the signaling using the narrower transmission beam may comprise msg3.

The access node may signal, to the user equipment, an indication of resources that will be used for transmitting the at least one reference signal.

The indication of resources may be signaled in response to the receipt of the preamble. For example, this indication may be signaled in a random access response. For example, this indication may be comprised in an msg2.

The at least one reference signal may comprise at least one tracking reference signal.

An advantage of the presently described techniques is that invention is that the RACH procedure is not delayed due to the UE beam refinement between msg1 and msg3. It is embedded within RACH, with dedicated reference signal between Msg2 and Msg3.

In general, the above describes operations that may be performed for increasing the efficiently of random access procedures. In particular, the following is directed towards providing a mechanism by which a user equipment, UE, can refine its transmission beam from a broad beam to a narrow beam during a random access procedure. This may assist the user equipment in saving energy resources, as a narrower beam may be associated with a lower transmission power than a broad beam.

The above-described mechanisms may be applied to any UE that is looking to establish or reestablish synchronization with a network. This may be because of a variety of different reasons.

For example, the UE may attempt to establish or reestablish synchronization with a network during:
i) an initial access of the UE from an RRC idle mode;
ii) an RRC Connection Re-establishment procedure;
iii) Handover;
iv) downlink or uplink data arrival when the UE is in an RRC connected mode when the uplink synchronisation status is determined to be “non-synchronised”;
v) a transition from a UE RRC inactive mode;
vi) a time to establish time alignment for secondary Cell addition;
vii) a request for other system information; and/or
viii) beam failure recovery (e.g., when a beam is incorrectly aligned).

The foregoing description has provided by way of non-limiting examples a full and informative description of some examples. However, various modifications and adaptations may become apparent to those skilled in the relevant arts in view of the foregoing description, when read in conjunction with the accompanying drawings and the claims. However, all such and similar modifications of the teachings will still fall within the scope of the claims.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software code, logic or any combination thereof. For example, some aspects may be implemented in hardware, while other aspects may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor-based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 11 and/or FIG. 12, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware code. The term circuitry also covers, for example integrated device.

Implementations of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further implementation comprising a combination of one or more implementations with any of the other implementations previously discussed.

### Clauses

The following presents various features of the above as clauses.

According to a first clause, there is provided an apparatus for a user equipment, the apparatus comprising: at least one processor; and at least one memory comprising software code that, when executed by the at least one processor, causes the apparatus to perform: transmitting, to an access network node using a broad beam transmission during a random access procedure, a preamble indicating whether the user equipment is requesting to perform beam refinement for transmission beams during the random access procedure.

According to a second clause, there is provided an apparatus as per clause 1, wherein the preamble indicates that the user equipment is requesting to perform beam refinement for transmission of beams during the random access procedure, and the apparatus being caused to perform: receiving, from the access network node, at least one reference signal during the random access procedure; sweeping the at least one reference signal to determine a narrower transmission beam than the broad beam; and transmitting, during the random access procedure, signaling using the narrower transmission beam.

According to a third clause, there is provided an apparatus in accordance with the second clause, wherein the signaling using the narrower transmission beam comprises physical uplink shared channel signaling.

According to a fourth clause, there is provided an apparatus as claimed in any of the second and third clauses, the apparatus being caused to perform: receiving, from the access network node, an indication of resources that will be used for transmitting the at least one reference signal; and using the indication of resources to locate the at least one reference signal.

According to a fifth clause, which may refer to any preceding clause, the indication of resources may be received in response to the transmission of the preamble.

According to a sixth clause, which may refer to any preceding clause, at least one reference signal may comprise at least one tracking reference signal.

According to a seventh clause, which may refer to any preceding clause preamble indicates that the user equipment is requesting to perform beam refinement for transmission beams during the random access procedure, and the apparatus being caused to perform: prior to transmitting the preamble, determining that the user equipment is in a low power state or does not have sufficient power to transmit all signaling for completing the random access procedure using the broad beam, wherein the preamble is transmitted in response to said determining.

According to an eight clause, there is provided an apparatus for an access node, the apparatus comprising: at least one processor; and at least one memory comprising software code that, when executed by the at least one processor, causes the apparatus to perform: receiving, from a user equipment using a broad beam transmission during a random access procedure, a preamble indicating whether the user equipment is requesting to perform beam refinement for transmission beams during the random access procedure.

According to a ninth clause, which may refer to the eighth clause, the preamble indicates that the user equipment is requesting to perform beam refinement for transmission of beams during the random access procedure, and the apparatus being caused to perform: signaling, to the user equipment, at least one reference signal during the random access procedure; and receiving, from the user equipment, during the random access procedure, signaling using a narrower transmission beam than the broad beam.

According to a tenth clause, which may refer to the ninth clause, wherein the signaling using the narrower transmission beam comprises physical uplink shared channel signaling.

According to an eleventh clause, which may refer to any of the ninth and tenth clauses, the apparatus being caused to perform: signaling, to the user equipment, an indication of resources that will be used for transmitting the at least one reference signal.

According to a twelfth clause, which may refer to the eleventh clause, the indication of resources is signaled in response to the receipt of the preamble.

According to a thirteenth clause, which may refer to any of the ninth to twelfth clauses, the at least one reference signal comprises at least one tracking reference signal.

1-23. (canceled)

24. An apparatus comprising at least one processing core and at least one memory storing instructions that, when executed by the at least one processing core, cause the apparatus at least to:
transmit, to an access network node using a broad beam transmission during a random access procedure, a preamble indicating whether the apparatus is requesting to perform beam refinement for transmission beams during the random access procedure.

25. The apparatus according to claim 24, wherein the preamble indicates that the apparatus is requesting to perform beam refinement for transmission of beams during the random access procedure, and the at least one processing core and the at least one memory storing instructions that, when executed by the at least one processing core, further cause the apparatus at least to:
receive, from the access network node, at least one reference signal during the random access procedure;
sweep the at least one reference signal to determine a narrower transmission beam than the broad beam; and
transmit, during the random access procedure, signaling using the narrower transmission beam.

26. The apparatus according to claim 25, wherein the signaling using the narrower transmission beam comprises physical uplink shared channel signaling.

27. The apparatus according to claim 25, wherein the at least one processing core and the at least one memory storing instructions that, when executed by the at least one processing core, further cause the apparatus at least to:
receive, from the access network node, an indication of resources to be used for transmitting the at least one reference signal; and
use the indication of resources to locate the at least one reference signal.

28. The apparatus according to claim 27, wherein the indication of resources is received in response to the transmission of the preamble.

29. The apparatus according to claim 25, wherein the at least one reference signal comprises at least one tracking reference signal.

30. The apparatus according to claim 24, wherein the preamble indicates that the apparatus is requesting to perform beam refinement for transmission beams during the random access procedure, and wherein the at least one processing core and the at least one memory storing instructions that, when executed by the at least one processing core, further cause the apparatus at least to:
determine, prior to transmitting the preamble, that the apparatus is in a low power state or does not have sufficient power to transmit all signaling for completing the random access procedure using the broad beam, wherein the preamble is transmitted in response to said determining.

31. A method comprising:
transmitting, to an access network node using a broad beam transmission during a random access procedure, a preamble indicating whether an apparatus is requesting to perform beam refinement for transmission beams during the random access procedure.

32. The method according to claim 31, wherein the preamble indicates that the apparatus is requesting to perform beam refinement for transmission of beams during the random access procedure, and the method further comprises: receiving, from the access network node, at least one reference signal during the random access procedure; sweeping the at least one reference signal to determine a narrower transmission beam than the broad beam; and transmitting, during the random access procedure, signaling using the narrower transmission beam.

33. The method according to claim 32, wherein the signaling using the narrower transmission beam comprises physical uplink shared channel signaling.

34. The method according to claim 32, further comprising:
receiving, from the access network node, an indication of resources to be used for transmitting the at least one reference signal; and using the indication of resources to locate the at least one reference signal.

35. The method according to claim 34, wherein the indication of resources is received in response to the transmission of the preamble.

36. The method according to claim 32, wherein the at least one reference signal comprises at least one tracking reference signal.

37. The method according to claim 31, wherein the preamble indicates that the apparatus is requesting to perform beam refinement for transmission beams during the random access procedure, and the method further comprises: determining, prior to transmitting the preamble, that the apparatus is in a low power state or does not have sufficient power to transmit all signaling for completing the random access procedure using the broad beam, wherein the preamble is transmitted in response to said determining.

38. An apparatus comprising at least one processing core and at least one memory storing instructions that, when executed by the at least one processing core, cause the apparatus at least to:
receive, from a user equipment using a broad beam transmission during a random access procedure, a preamble indicating whether the user equipment is requesting to perform beam refinement for transmission beams during the random access procedure.

39. The apparatus according to claim 38, wherein the preamble indicates that the user equipment is requesting to perform beam refinement for transmission of beams during the random access procedure, and the at least one processing core and the at least one memory storing instructions that, when executed by the at least one processing core, further cause the apparatus at least to:
signal, to the user equipment, at least one reference signal during the random access procedure; and
receive, from the user equipment, during the random access procedure, signaling using a narrower transmission beam than the broad beam.

40. The apparatus according to claim 39, wherein the signaling using the narrower transmission beam comprises physical uplink shared channel signaling.

41. The apparatus according to claim 38, wherein the at least one processing core and the at least one memory storing instructions that, when executed by the at least one processing core, further cause the apparatus at least to:
signal, to the user equipment, an indication of resources to be used for transmitting the at least one reference signal.

42. The apparatus according to claim 41, wherein the indication of resources is signaled in response to the receipt of the preamble.

43. The apparatus according to claim 38, wherein the at least one reference signal comprises at least one tracking reference signal.
